(19) United States
(12) Patent Application Publication
(10) Pub. No.: US 2002/0040363 A1
(43) Pub. Date: Apr. 4, 2002

(54) Automatic hierarchy based classification

(76) Inventors: Gadi Wolfman, Bat Yam (IL); Ehud Rivlin, Haifa (IL); Yossef Matias, Tel Aviv (IL); Eytan Ruppin, Maccabim Reut (IL); Solan Tsach, Tel-Aviv (IL); Evgeniy Gabrilovich, Herzlia (IL); Lev Finkelstein, Netanya (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/879,916

(22) Filed: Jun. 14, 2001

Related U.S. Application Data
(60) Provisional application No. 60/211,483, filed on Jun. 14, 2000.
(60) Provisional application No. 60/212,594, filed on Jun. 19, 2000.
(60) Provisional application No. 60/237,513, filed on Oct. 4, 2000.

(51) Int. Cl. G06F 17/30

(52) U.S. Cl. 707/5; 707/101

(57) ABSTRACT

A method and system for classification, including the steps of searching a data structure including categories for elements related to an input, calculating statistics describing the relevance of each of the elements to the input, ranking the elements by relevance to the input, determining if the ranked elements exceed a threshold confidence value, and returning a set of elements from the ranked elements when the threshold confidence value is exceeded.

### CROSS REFERENCE TO RELATED APPLICATIONS

This application claims the priority of U.S. Provisional Patent Application No. 60/211,483, filed Jun. 14, 2000, which is incorporated in its entirety herein by reference.

This application claims the priority of U.S. Provisional Patent Application No. 60/212,594, filed Jun. 19, 2000, which is incorporated in its entirety herein by reference.

This application claims the priority of U.S. Provisional Patent Application No. 60/237,513, filed Oct. 4, 2000, which is incorporated in its entirety herein by reference.

### FIELD OF THE INVENTION

The present invention relates generally to classification in a pre-given hierarchy of categories.

### BACKGROUND OF THE INVENTION

Whole fields have grown up around the topic of information retrieval (IR) in general and of the categorization of information in particular. The goal is making finding and retrieving information and services from information sources such as the World Wide Web (web) both faster aud more accurate. One current direction in IR research and development is a categorization and search technology that is capable of “understading” a query and the target documents. Such a system is able to retrieve the target documents in accordance with their semantic proximity to the query.

The web is one example of an information source for which classification systems are used. This has become useful since the web contains an overwhelming amount of information about a multitude of topics, and the information available continues to increase at a rapid rate. However, the nature of the Internet, is that of an unorganized mass of informatiom. Therefore, in recent years a number of web sites have made use of hierarchies of categories to aid users in searching and browsing for information. However, since category descriptions are short, it is often a matter of trial and error finding relevant sites.

### SUMMARY OF THE INVENTION

There is provided, in accordance with an embodiment of the present invention, a method for classification. The method includes the steps of searching a data structure including categories for elements related to an input, calculating statistics describing the relevance of each of the elements to the input, ranking the elements by relevance to the input, determining if the ranked elements exceed a threshold confidence value, and returning a set of elements from the ranked elements when the threshold confidence value is exceeded.

### BRIEF DESCRIPTION OF THE DRAWINGS

The present invention will be understood and appreciated more fully from the following detailed description taken in conjunction with the appended drawings in which:

FIG. 1 is a block diagram illustration of a classification system constructed and operative in accordance with an embodiment of the present invention;

FIG. 2 is a block diagram illustration of an exemplary knowledge DAG used by the classification system of FIG. 1, constructed and operative in accordance with an embodiment of the present invention;

FIG. 3 is a block diagram illustration of the knowledge DAG 14 of FIG. 2 to which customer information has been added, constructed and operative in accordance with an embodiment of the present invention; and

FIG. 4 is a flow chart diagram of the method performed by the classifier of FIG. 1, operative in accordance with an embodiment of the present invention.

### DETAILED DESCRIPTION OF THE PRESENT INVENTION

### Overview

Applicants have designed a system and method for automatically classifying input according to categories or concepts. For any given input, generally natural language text, the system of the present invention outputs a ranked list of the most relevant locations found in a data structure of categories. The system may also search remote information sources to find other locations containing information related to the input but categorized differently. Such a system is usable for many different applications, for example, as a wireless service engine, an information retrieval service engine, for instant browsing, or for providing context dependent ads.

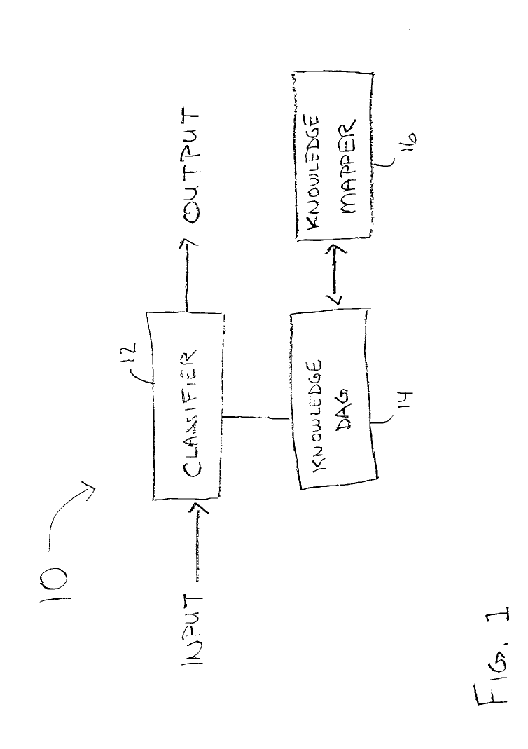

Reference is now made to FIG. 1, which is a block diagram illustration of a classification system 10, constructed and operative in accordance with an embodiment of the present invention. Classification system 10 comprises a classifier 12, a knowledge DAG (directed acyclic graph) 14, and an optional knowledge mapper 16. Classification system 10 receives input comprising text and optionally context, and outputs a list of relevant resources.

Knowledge DAG 14 defines a general view of human knowledge in a directory format constructed of branches and nodes. It is essentially a reference hierarchy of categories wherein each branch and node represents a category. Classification system 10 analyzes input and classifies it into the predefined set of information represented by knowledge DAG 14 by matching the input to the appropriate category. The resources available to a user are matched to the nodes of knowledge DAG 14, enabling precise mapping between any textual input, message, email, etc. and the most appropriate resources corresponding with it.

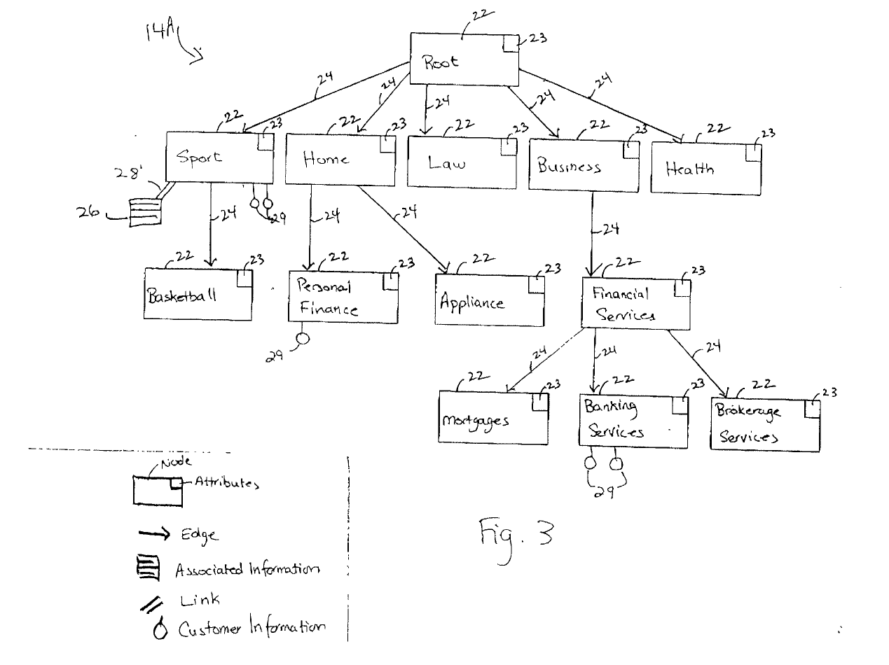

Optional knowledge mapper 16 allows the user to map proprietary information or a specialized DAG onto knowledge DAG 14 and in doing so it may also prioritize and set properties that influence system behavior. This process will be described hereinbelow in more detail with respect to FIG. 3.

### Data Structures

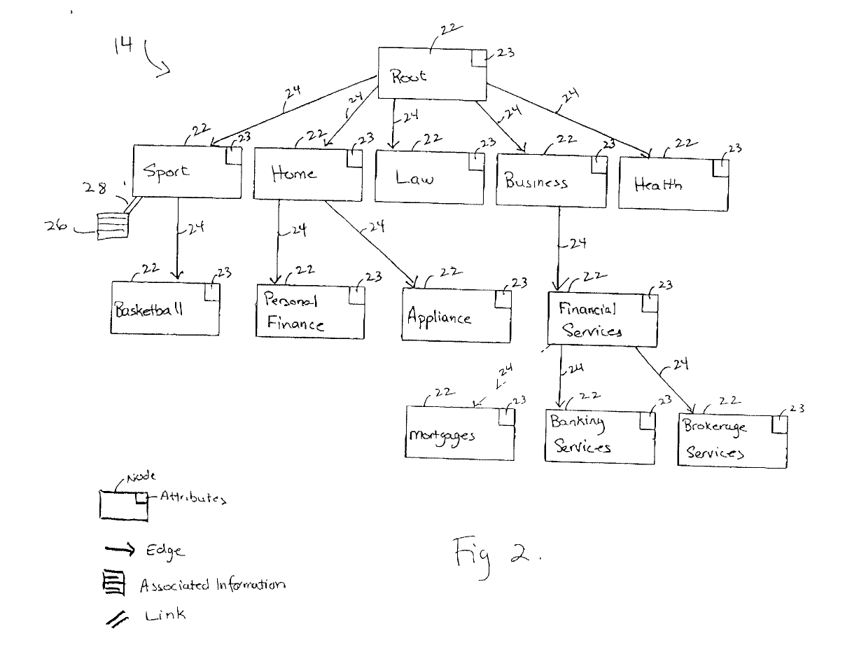

FIG. 2, to which reference is now made, is a block diagram illustration of an exemplary knowledge DAG 14. Such DAGs are well known in the art, and commercial versions exist, for example, from the DMOZ (open directory project, details available at http://dmoz./org, owned by Netscape). Knowledge DAG 14 comprises nodes 22, edges 24, associated information 26, and links 28. Knowledge DAG 14 may comprise hundreds of thousands of nodes 22 and millions of links 28. Identical links 28 may appear in more than one node 22. Additionally, different nodes 22 may contain the same keywords.

For convenience purposes only, knowledge DAG 14 of FIG. 2 is shown as a tree with no directed cycles. It is understood however, that the invention covers directed acyclic graphs and is not limited to the special case of trees.

Nodes 22 each contain a main category by which they may be referred and which is a part of their name. Nodes 22 are named by their full path, for example, node 22B is named “root/home/personal finance”. Root node 22A is the ancestor node of all other nodes 22 in knowledge DAG 14.

Nodes 22 are connected by edges 24. For example, the nodes 22 of: sport, home, law, business, and health are all children of root node 22A connected by edges 24. Home node 22C has two children: personal finance and appliance. Nodes 22 further comprise attributes 23 comprising text including at least one topic or category of information, for example, sport, home, basketball, business, financial services, and mortgages. These may be thought of as keywords. Additionally, attributes 23 may contain a short textual summary of the contents of node 22.

Additionally, some nodes 22 contain a link 28 to associated information 26. Associated information 26 may comprise text that may include a title and a summary. The text refers to an information item, which may be a document, a database entry, an audio file, email, or any other instance of an object containing information. This information item may be stored for example on a World Wide Web (web) page, a private server, or in the node itself. Links 28 may be any type of link including an HTML (hypertext markup language) link, a URL (universal resource locator), or a path to a directory or file. Links 28 and associated information 26 are part of the structure of knowledge DAG 14.

Hierarchical classification systems of the type described with respect to FIG. 2 exist in the art as mentioned hereinabove. In these systems, which are generally created by human editors, the information available about individual nodes is generally limited to a few keywords. Thus, finding the correct category may be difficult. Furthermore, service providers may have proprietary information and services that they would like included in the resources available to users.

Reference is now made to knowledge mapper 16 (FIG. 1) and FIG. 3. FIG. 3 comprises a knowledge DAG 14A constructed and operative in accordance with the present invention. Knowledge DAG 14A comprises knowledge DAG 14 of FIG. 2 with the addition of customer information 29. Knowledge DAG 14A is the result of knowledge mapper 16 mapping customer-specific information to knowledge DAG 14. Similar elements are numbered similarly and will not be discussed further.

A customer using classification system 10 may have specific additional information he wants provided to a user. This information may comprise text describing a service or product, or information the customer wishes to supply to users and may include links. This information may be in the form of a list with associated keywords describing list elements. These services or information are classified and mapped by knowledge mapper 16 to appropriate nodes 22. They are added to nodes 22 as leaves and are denoted as customer information 29.

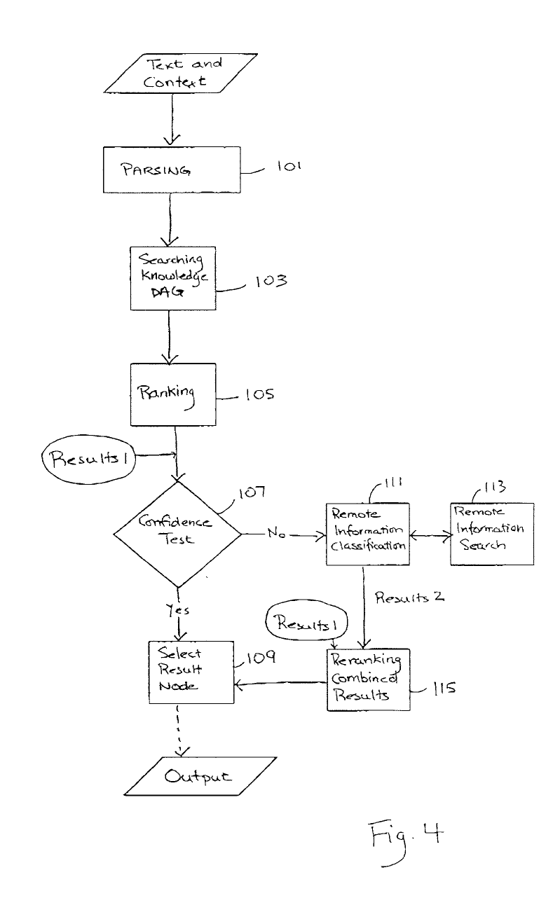

Knowledge mapper 16 uses classifier 12 to perform the mapping. This component is explained in detail hereinbelow with respect to step 103 of FIG. 4.

It is noted that customer information 29 is customer specific and not part of the generally available knowledge DAG 14. The information is “hung” off nodes 22 by knowledge mapper 16, as opposed to associated information 26, which is an integral part of knowledge DAG 14.

### Exemplary Applications

This system is usable for many different applications, for example, as a knowledge mapper, as a wireless service engine, an information retrieval service engine, for instant browsing, or for providing context-dependent ads. Many wireless appliances today, for example, cell phones, contain small display areas. This makes entry of large amounts of text or navigation through multiple menus tedious. The system and method of the invention may identify the correct services from DAG 14 using only a few words. Instant browsing, wherein a number of possible choices are given from the input, is especially useful in applications relating to a call center or voice portal. Finally, this system allows the placement of context-dependent ads in any returned information. Such an application is described in U.S. patent application Ser. No. 09/814,027, filed on Mar. 22, 2001, owned by the common assignee of the present invention, and which is incorporated in its entirety herein by reference.

The abovementioned application examples are not search engines and generally do not have a large amount of text or context available. Classification system 10 uses natural language in conjunction with a dynamic agent and returns services or information. Classification system 10 may additionally be used in conjunction with an information retrieval service engine to provide improved results.

### Classification Method

### Overview

FIG. 4, to which reference is now made is a flow chart diagram of the method performed by classifier 12, operative in accordance with an embodiment of the present invention. The description hereinbelow additionally refers throughout to elements of FIGS. 1, 2, and 3.

A user enters an input comprising text. Optionally, context may be input as well, possibly automatically. This input is parsed (step 101) using techniques well known in the art. These may include stemming, stop word removal, and shallow parsing. The stop word list may be modified to be biased for natural language processing. Furthermore, nouns and verbs may be identified and priority given to nouns. The above mentioned techniques of handling input are discussed for example in U.S. patent application Ser. No. 09/568,988, filed on May 11, 2000, and in U.S. patent application Ser. No. 09/524,569, filed on Mar. 13, 2000, owned by the common assignee of the present invention, and which is incorporated in its entirety herein by reference.

In searching knowledge DAG 14 (or 14A) (step 103), classifier 12 compares the individual words of input to the words contained in attributes 23 of each node 22. This comparison is made “bottom up”, fom the leaf nodes to the root. Each time a word is found, node 22 containing that word is given a “score”. These scores may not be of equal value; the scores are given according to a predetermined valuation of how significant a particular match may be.

For simplicity of the description, only two particular nodes 22 are considered in the exemplary scenario below. Additionally, equal score values of 1 are used, whereas hereinbelow, it will be explained that score values may differ. Node 22B “root/home/personal finance” (herein referred to as personal finance) may contain attributes 23: saving, interest rates, loans, investment funds, stocks, conservative funds, and high-risk funds. Node 22D “root/business/financial services/banking services” (herein referred to as banking services), on the other hand, may contain attributes 23: saving and interest rates. Additionally, personal finance node 22B may contain customer information 29, which contains the keywords myBank savings accounts, myBank interest rates, myBank conservative funds, and myBank high risk funds.

Given the input “conservative management of my savings” the following keyword matches to knowledge DAG 14 (or 14A) may be made. Personal finance matches the keywords saving and conservative fund and receives two scores, which may be added. Banking services only matches the keyword saving and receives one score. Matched nodes 22 are ranked (step 105) in order of the values of the scores, resulting, in this example, in personal finance being ranked as more relevant than banking services. A determination is made as to whether this results output passes a confidence test (step 107).

If the confidence test is passed, then up to a predetermined number of results are selected as described hereinbelow (step 109).

If the confidence test is not passed, further processing must be done. In remote information classification (step 111), customer information 29 may not be considered. Only the original knowledge DAG 14 may be used, without the results of knowledge mapper 16.

The input is sent as a query to various available search engines for a remote information search (step 113). An exemplary embodiment of such a search is described in U.S. patent application Ser. No. 09/568,988, filed on May 11, 2000, and in U.S. patent application Ser. No. 09/524,569, filed on Mar. 13, 2000, owned by the common assignee of the present invention, and which is incorporated in its entirety herein by reference. During the remote information classification (step 111), each of the returned result links may be compared to each link 28 on knowledge DAG 14. For each matched link 28, its associated node 22 is marked. If a result link is not found on knowledge DAG 14, the result link may be ignored. Nodes 22 which include many links 28 which were matched may indicate a “hotspot” or “interesting” part of knowledge DAG 14 and will be given more weight as described hereinbelow.

It is noted that knowledge DAG 14 is updated on a regular basis, so that the contained information is generally current and generally complete and so most result links are found among links 28. As mentioned hereinabove, identical links 28 may appear in different nodes 22. A result link may thus cause more than one node 22 to be marked.

All the links 28 of the marked nodes 22 are selected, even if the particular link 28 was not returned. These links are all tested for their relevance to the input, and any links 28 not considered relevant are discarded. Nodes 22 of links 28 that remain may be reranked and given scores. The method of testing the match between the input query and the description of a link 28 and the reranking of links 28, uses the reranking method described in U.S. patent application Ser. No. 09/568,988, filed on May 11, 2000 and in U.S. patent application Ser. No. 09/524,569, filed on Mar. 13, 2000. Both resulting lists of nodes 22, fom the search of knowledge DAG 14 and from the remote information search, are finally combined and reranked (step 115).

### Searching Knowledge DAG

Searching knowledge DAG 14 (step 103) comprises three main stages: computation of statistical information per word in the input query, summarization of information for all words for each node, and postprocessing, including the calculation of the weights and the confidence levels of each node.

Input comprises text and optionally context, which consist of words. Stemming, stop word removal, and duplicate removal, which are well known in the art, are performed first. The DAG searching module performs calculations on words wᵢ and collocations (wᵢ, wⱼ). (A collocation is a combination of words which taken together have a different compositional meaning than that obtained by considering each word alone, for example “general store”.)

### Statistics Per Word

For each node N and word w, a frequency f (N, w) is defined, which corresponds to the frequency of the word in the node. For each node, |N| is the number of items of associated information 26 to which there are links 28. |w(N)| is the number of those information items which contain word w in either the title and/or description. A set sons(N) is defined as the set of all the children of N and the number in the set is |sons(N)|.

$$Equation 1 : \\ \begin{matrix}f ( N , w ) = \{ \begin{matrix}a : ( \frac{\vert w ( N ) \vert}{\vert N \vert} + {\sum }_{{N}^{′} ∈ sons ( N )} f ( {N}^{′} , w ) ) / ( 1 + \vert sons ( N ) \vert ) , \\ b : {\sum }_{{N}^{′} ∈ sons ( N )} f ( {N}^{′} , w ) / \vert sons ( N ) \vert\end{matrix} & \end{matrix}$$

where a: is the case where |N|>0 and b: otherwise (i.e. zero information items containing word w).

Note that in equation 1,

$$\frac{\vert w ( N ) \vert}{\vert N \vert}$$

refers to the node itself and that Σ_{N′esons(N)}f(N′, w) is the average of the children. Included in the set of children is the special case of N₀, the node itself. The term is divided by 1+ the number of children (thus adding the node itself in the total) and thus the frequency is a weighted average related to the number of children. A weighted average is used since knowledge DAG 14 may be highly unbalanced, with some branches more populated than others.

In the case of a node that contains a word w of the input in its name, the frequency f (N, w) is set to 1, since all the associated information 26 relates to word w. For example, in the input query “what is New York City's basketball team”, the word “basketball” matches node 22E “root/sport/basketball” FIG. 2) and this node would be given a frequency of 1.

In the case of a collocation comprising (w₁, w₂), if node N contains k information items containing both w₁ and w₂ in their titles, the frequency may be greater than 1. In this case, both f (N, w₁) and f (N, w₂) are set to log₂ (1+log₂(1+k)). An example of a collocation is “Commerce Department”. These words together have a significance beyond the two words individually and thus have a special frequency calculation for these two words.

### Node Level Statistics

IDF (inverse document frequency) is a measure of the significaace of a word w. A higher IDF value corresponds to a larger number of instances of w being matched in the node, implying that a higher significance should possibly be given to the node. Given d, the number of information items in a node, and d₂, the number of these information items containing word w, the IDF is defined as:

$$Equation 2 : \\ idf ( w ) = log \frac{d}{{d}_{w}} .$$

A separate weight component may be calculated for each word of text t and context c, Wₜ and W_{c} respectively. cₜ and c_{c} define the text and context relative weight respectively. These are constants, and exemplary values are cₜ=1 and c_{c}=0.5. The following equations may be used:

$$Equation 3 : \\ \begin{matrix}{W}_{t} ( N ) = {\sum }_{w ∈ T} log ( 1.0 + {c}_{r} f ( N , w ) ) idf ( w ) , and \\ {W}_{c} ( N ) = {\sum }_{w ∈ C} log ( 1.0 + {c}_{c} f ( N , w ) ) idf ( w ) . & \end{matrix}$$

Additionally, it is possible to predefine “bonuses” to give extra weight to specific patterns of text and context word matching.

The node significance is a measure of the importance of a node, independent of a particular input query. Generally the higher a node is in the hierarchy of knowledge DAG 14, the greater its significance. The total number of information item links in node N and its children is defined as |subtree(N)|. The node significance Nₛ is measured for every node and is defined as:

### Equation 5

Nₛ=log₂(1+|subtree(N)|)

### Node Weight

The values calcated in equations 3, 4, and 5 may be combined to give a final node weight W(N). Equation 6, which follows, includes may include two constants α and β. Increasing α gives a greater weighting to nodes with either a high value of Wₜ(N) or W_{c}(N). Increasing β gives more weight to nodes where the difference between Wₜ(N) and W_{c}(N) is minimal.

### Equation 6

W(N)=(α(Wₜ(N)+W_{c}(N))+β\sqrt{Wₜ(N)W_{c}(N)})·Nₛ

Further heuristics may be performed on the node weights. For example, nodes containing geographical locations in their names, in cases where these names do not appear in either the text or the context, may receive a factor which decreases their weight. Such a case is referred to as a false regional node. Nodes corresponding to an encyclopedia, a dictionary, or a news site may be removed. In cases where the text is short and there is no context, all the top level nodes (e.g. the children of root) not containing all the text words may be removed. Further heuristics are possible and are included within the scope of this invention.

### Node Confidence Level

Finally, a confidence level may be calculated for each node. Exemplary parameters which may be used are the text word confidence, the link category, and Boolean values. Text word confidence is defined as a ratio between the text words found in the node (i.e. f (N, w)>0) and all the words in the text. Furthermore, proper names may receive a bonus factor which would yield a greater confidence level as compared to regular words. For example, a confidence level for words in which proper names occur may be multiplied by 3.

Link category receives a value based on the number of links. For zero or one link, link category may be set to 0. For two links, link category may be set 1. For three to five links link category may be set to 2. Finally, for more than five links, link category may be set to 3.

There may be a first Boolean value indicating the case in which the current node gets all its weight from a single link containing a collocation that appears in the input query. There may be a second Boolean value indicating the case in which the current node is a false regional node.

### Reranking

All remaining matched nodes are reranked according to both weight and confidence levels. Nodes N₁ and N₂ may be compared according to the following rules given in lexicographic order.

1. If context is given, nodes may be compared according to their weights W(N₁) and W(N₂). If no context is given this rule may be skipped.

2. Nodes with higher text word confidence may be considered preferable to nodes with lower text word confidence.

3. Nodes with higher link category values may be considered preferable to nodes with lower link category values.

4. False regional nodes may be less preferred than regular nodes.

5. Nodes not falling into any of the above categories may be ranked in a predetermined, possibly arbitrary manner.

Pairs of nodes may be sorted by the above scheme, starting from rule 1, until one node is ranked higher than the other. For example, if W(N₁) and W(N₂) are equal, then Wₜ(N₁) and Wₜ(N₂) are compared. The final result is a ranked list of nodes.

It is noted that other ranking schemes are possible within the scope of this invention, including that described hereinbelow with respect of equation 7.

### Remote Infomation Classification

The remote information classification (step 111) uses information returned by search engines from other external searchable data collections. A goal of this part of the method is to find the most probable locations of relevant links 28 in knowledge DAG 14. An important feature of this method is that it may be used even in cases in which none of the words of the input query are present in attributes 23 of nodes 22.

As mentioned hereinabove, if the confidence value of the list of nodes 22 returned by searching knowledge DAG (in step 103) is higher than a predetermined threshold value, no further steps need be taken to find additional nodes 22. However if the confidence value fails the confidence test (step 107), further processing may be performed.

The input queries may be sent to remote information search engines (step 113). These search engines may use both text and context if available and may generate additional queries. Semantic analysis may be used on the text and context in generating the additional queries. An exemplary embodiment of a remote information search engine, using text and context is described in U.S. patent application Ser. No. 09/568,988, filed May 11, 2000 and in U.S. patent application Ser. No. 09/524,569, filed on Mar. 13, 2000, which is incorporated in its entirety herein by reference. Queries may be sent in parallel to several different search engines possibly searching different information databases with possibly different queries. Each search engine may return a list of results, providing the locations of the results that were found, and may also provide a title and summary for each item in the list. For example, a search engine searching the web will return a list of URLs.

Continuing with the exemplary query “conservative management of my savings” described hereinabove, the followed scenario may occur. The search engine returns the following URLs: “www.bankrates.com” and “www.securities-list.com”. A remote information classification module looks for all matches of these links in knowledge DAG 14 and selects the nodes 22 associated with the links 28 that were found. For any result link not found in knowledge DAG 14, an attempt may be made to locate partial matches to the result link. The link “www.bankrates.com” may be found in banking services node 22F. The link “www.securities-list.com” may be found in personal finance node 22B. The matched nodes in this example would be banking services node 22F and personal finance node 22B.

All the matched nodes are combined in a second results list which may be reranked. Reranking of the results list may score the matched nodes using analysis of the relation of locations to each other of nodes 22 in the results list as explained hereinbelow.

### Classification Reranking

The location related scoring is performed by a function that scans all the paths in which a given node i appears. The function checks how many nodes on the path were matched by the remote information classification module. In other words, this function sums the score of all ancestor nodes Aᵢ of node i. This check is performed from root node 22 down. This function may give a higher ranking to nodes 22 that share common ancestors. The reranked list may be output as results2.

Given that sᵢ is the score of node i, that jₖ is the depth level of node k which is the ancestor of node i, f(nₖ) is the occurrence of node k in the results, and that σ and b are predefined parameters the following may be calculated:

$$Equation 7 : \\ \begin{matrix}{s}_{i} = b \cdot {\sum }_{k ∈ {A}_{j}} exp ( - \frac{{j}_{k}^{2} \cdot f ( {n}_{k} )}{{σ}^{2}} ) & \end{matrix}$$

### Combined Results Reranking

Reranking combined results (step 115) scores the all matched nodes and may use any of the techniques described hereinabove. The two results lists may be used, results1 from the search of knowledge DAG 14 and results2 from the remote information classification.

Any results lists are compared and nodes 22 appearing in more that one list may receive a bonus. The lists may be combined into a single list and duplicate nodes 22 may be removed. The names of nodes 22 in the results list may be compared with the input text and context. In the case of a matched word, the matching node and all its predecessors may receive a bonus.

The location related scoring as describe with relation to equation 7 may be performed on the combined list, resulting in a single, ranked list. Finally, the scored nodes may be output.

It will be appreciated by persons silled in the art that the present invention is not limited by what has been particularly shown and described herein above. Rather the scope of the invention is defined by the claims that follow:

What is claimed is:

1. A method for classification comprising the steps of:
searching a data structure comprising categories for elements related to an input;
calculating statistics describing the relevance of each of said elements to said input;
ranking said elements by relevance to said input;
determining if said ranked elements exceed a threshold confidence value; and
returning a set of elements from said ranked elements when said threshold confidence value is exceeded.
